(19) United States
(12) Patent Application Publication
(10) Pub. No.: US 2018/0063220 A1
(43) Pub. Date: Mar. 1, 2018

(54) SYSTEMS AND METHODS TO PROVIDE HYPERTEXT TRANSFER PROTOCOL 2.0 OPTIMIZATION THROUGH MULTIPLE LINKS

(71) Applicant: Citrix Systems, Inc., Fort Lauderdale, FL (US)

(72) Inventors: Praveen R. Dhanabalan, Bangalore (IN); Tarun K. Hukmichand, Karnataka (IN)

(21) Appl. No.: 15/251,747

(22) Filed: Aug. 30, 2016

(51) Int. Cl. H04L 29/08; H04L 29/06

(52) U.S. Cl. CPC H04L 67/02; H04L 67/322; H04L 67/28; H04L 67/42

(57) ABSTRACT

A method for optimizing different data streams which flow through an HTTP/2 connection. The methods involve: establishing at least first and second network connections between a first network appliance and a second network appliance prior to knowing how many HTTP/2 data streams are being multiplexed over the HTTP/2 connection; determining, by the first network appliance, a QoS of each WAN link of a plurality of WAN links; receiving, by the first network appliance, a first HTTP/2 data packet communicated over the HTTP/2 connection; obtaining a first priority designator and a first data stream's identifier contained in the packet header of the first HTTP/2 data packet; and allocating the first HTTP/2 data packet of a first data stream to the first or second network connection based on the first data stream's priority and the WAN links' QoS.

### FIELD OF THE INVENTION

This document relates generally to network optimization. More particularly, this document relates to systems and methods for providing HyperText Transfer Protocol (“HTTP”) 2.0 (“HTTP/2”) optimization through multiple links.

### BACKGROUND OF THE INVENTION

A middlebox (or network appliance) is a network device that transforms, inspects, filters or otherwise manipulates traffic for various purposes. The middlebox can include, but is not limited to, a firewall, an Intrusion Detection System (“IDS”), a Network Address Translator (“NAT”), a Wide Area Network (“WAN”) optimizer, a load balancer and a WAN virtualizer. The WAN virtualizer enables network managers to use multiple WAN connections to augment or replace individual private WAN connections. WAN virtualization is an end-to-end appliance solution. As such, two WAN virtualizers are needed to provide the multiple WAN connections. These two WAN virtualizers provide a pair of WAN virtualizers connected via different WAN networks.

### SUMMARY

The present document generally relates to implementing systems and methods for optimizing different data streams which flow through an HTTP/2 connection established between a first and second remote computing devices (e.g., a client and a server). The methods comprise: establishing at least first and second network connections between a first network appliance and a second network appliance prior to knowing how many HTTP/2 data streams are being multiplexed over the HTTP/2 connection; determining, by the first network appliance, a QoS of each WAN link; receiving, by the first network appliance, a first HTTP/2 data packet communicated over the HTTP/2 connection; obtaining a first priority designator and a first data stream's identifier contained in the packet header of the first HTTP/2 data packet; and allocating the first HTTP/2 data packet of a first data stream to the first or second network connection based on the first data stream's priority and the WAN links' QoS.

In some scenarios, the methods also involve: monitoring, by the first network appliance, a non-HTTP/2 connection; and communicating non-HTTP data packets over the WAN links without performance of HTTP/2-based proxying functions by the first network appliance.

In those or other scenarios, the methods further involve: receiving, by the first network appliance, a second HTTP/2 data packet multiplexed over the HTTP/2 connection; and processing the second HTTP/2 data packet to obtain a second priority designator and a second data stream's identifier contained in the packet header thereof. The first network appliance performs operations to establish a third network connection between the first network appliance and the second network appliance when the first and second data streams are different data streams indicating that two different data streams are being multiplexed over the HTTP/2 connection. The first network appliance then determines the QoS of the first, second and third network connections. The second HTTP/2 packet is allocated to a respective one of the first, second and third network connections based on (a) the second data stream's priority specified by the second priority designator and (b) the QoS of the first, second and third network connections. The HTTP/2 data packets of the second data stream are allocated to one of the first, second and third network connections which is different than the network connections to which HTTP/2 data packets of the first data stream are allocated.

### DESCRIPTION OF THE DRAWINGS

Embodiments will be described with reference to the following drawing figures, in which like numerals represent like items throughout the figures, and in which:

FIG. 1 is an illustration of an exemplary system in which WAN virtualization is employed.

FIG. 2 is an illustration of an exemplary computing device.

FIG. 3 is an illustration of an exemplary computing device.

FIG. 4 is an illustration of an exemplary architecture for a network appliance (e.g., a WAN virtualizer) configured to process communications between client devices and servers.

FIG. 5 is an illustration of another exemplary architecture for another network appliance.

FIGS. 6a and 6b (collectively referred to as “FIG. 6”) is a flow diagram of an exemplary method for providing HTTP/2 optimization through multiple links.

### DETAILED DESCRIPTION OF THE INVENTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

The present disclosure concerns systems and methods for providing HTTP/2 optimization through multiple links. The HTTP/2 traffic is optimized based on stream priorities over multiple links. The advantages of the present solution are: (1) quick delivery of a high priority stream within a single HTTP/2 connection; and (2) low priority streams do not take the resource of a high quality path in an intermediary network (e.g., a WAN). The resource can include, but is not limited to, communication links between end nodes (e.g., a data center node and a branch node of a business entity).

HTTP/2 is a recently released revision to the HTTP network protocol used by the World Wide Web (“WWW”). HTTP/2 works at the application layer of an HTTP protocol stack for encapsulating data packets generated by various applications (e.g., Microsoft Outlook® and/or Microsoft Exchange®). The HTTP protocol stack is well known in the art, and therefore will not be described herein. The encapsulated data packets are referred to herein as HTTP/2 packets. The communication of HTTP/2 packets between network nodes (e.g., a client device and a server) involves multiplexing HTTP/2 packets of a plurality of data streams within a single HTTP/2 communications link. Techniques for multiplexing data packets are well known in the art, and therefore will not be described herein. Any known or to be known multiplexing technique can be used herein without limitation. Each data stream has a priority assigned thereto. A priority designator is contained in the header of each HTTP/2 packet. The priority designator dictates how network resources are allocated. The resources can include HTTP/2 communication links and buffers.

HTTP/2 is currently supported by Citrix® network appliances. Citrix® network appliances comprise network virtualizers. A network virtualizer is used to view the following: the services and service groups that are bound to a virtual server; the monitors that are bound to each service; the policies that are bound to the virtual server; the policy labels; configuration details of any displayed element; load balancing virtual server statistics; statistical information; and a comparative list of all the parameters.

The present solution adds a novel HTTP-based proxy to the network virtualizer. The HTTP-based proxy comprises a computer system or an application that acts as an intermediary for HTTP/2 packet communication between end nodes (e.g., client devices and servers) so as to provide an interface between a first network (e.g., a Local Area Network (“LAN”)) and a second network (e.g., a WAN), as discussed in detail below. In this regard, the network virtualizer is generally configured to: receive data packets from an end node (e.g., a client device or a server); process the data packets to identify HTTP/2 packets and non-HTTP packets; cause the non-HTTP packets to bypass the HTTP-based proxying functions; parse a priority designator from a header of each HTTP/2 packet; and forward to the HTTP-based proxy the priority designators, the HTTP/2 packets and Current Network Condition (“CNC”) information specifying a Quality of Service (“QoS”) for each established communications path between the network virtualizer and another network virtualizer. The HTTP-based proxy then performs operations to cause the HTTP/2 packets to be sent over respective connections (established between the two network virtualizers) based on the priority designators and CNC information; and/or dynamically adjust a total number of connections established between the two network virtualizer based on a total number of data streams being sent over at least one HTTP/2 communication link established between the end node (e.g., a client device or server) and a network virtualizer.

Exemplary System Implementing Network Virtualization

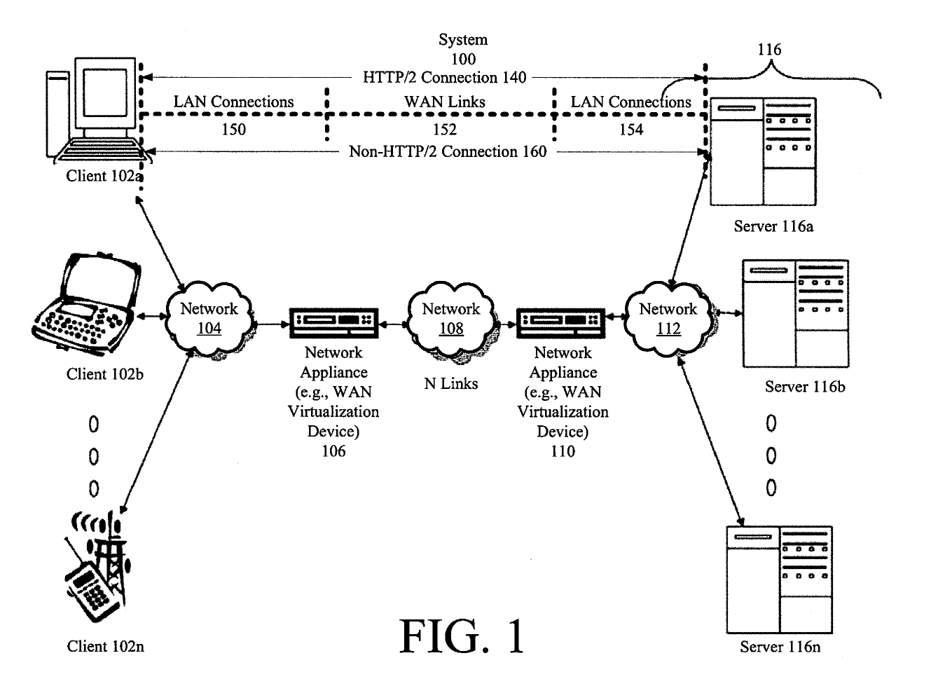

Referring now to FIG. 1, there is provided an illustration of an exemplary system 100. System 100 comprises a plurality of clients 102a, 102b, . . . , 102n (collectively referred to as “clients 102”) in communication with a plurality of servers 116a, 116b, . . . , 116n (collectively referred to as “servers 116”) via at least one network 104, 108, 112. Each client 102 has the capacity to function as both a client node seeking access to applications on a server 116 and as an application server providing access to hosted applications for other clients. For example, a client 102a requests execution of various applications hosted by the servers 116 and receives outputs of the results of the application execution for display. In some scenarios, the clients 102 reside in a branch office of a business organization.

Servers 116 include, but are not limited to, file servers, application servers, web servers, proxy servers, and/or gateway servers. Each server 116 may have a capacity to function as either an application server or as a master application server. Each server 116 may include an active directory. In some scenarios, one or more of the servers 116 receive(s) requests from clients 102, forwards the requests to other servers, and responds to the requests. In some scenarios, the servers 116 reside in a data center of the business organization or another business organization.

As shown in FIG. 1, the clients 102 communicate with servers 116 via a pair of network appliances 106, 110. The network appliances 106, 110 are designed, configured or adapted to facilitate the use of multiple WAN links to augment or replace individual private WAN links. As such, the network appliances 106, 110 comprise WAN virtualization devices. The WAN virtualization devices are generally configured to facilitate: the optimization, securement and control of the delivery of enterprise and cloud services; and maximize the end user experience for all users (including mobile clients).

Network appliance 106 is connected to clients 102 via network 104. Network appliance 106 is also connected to network appliance 110 via network 108. Network appliance 110 is connected to servers 116 via network 112. Networks 104, 108, 112 can be the same type of networks or different types of networks. Each network 104, 112 can include, but is not limited to, a LAN. The LAN includes, but is not limited to, an Intranet. The networks 104, 112 can be public networks, private networks or a combination of public and private networks. Network 108 comprises a WAN. The WAN includes, but is not limited to, the Internet or the WWW. The topology of each network 104, 108, 112 may be a bus, star or ring network typology.

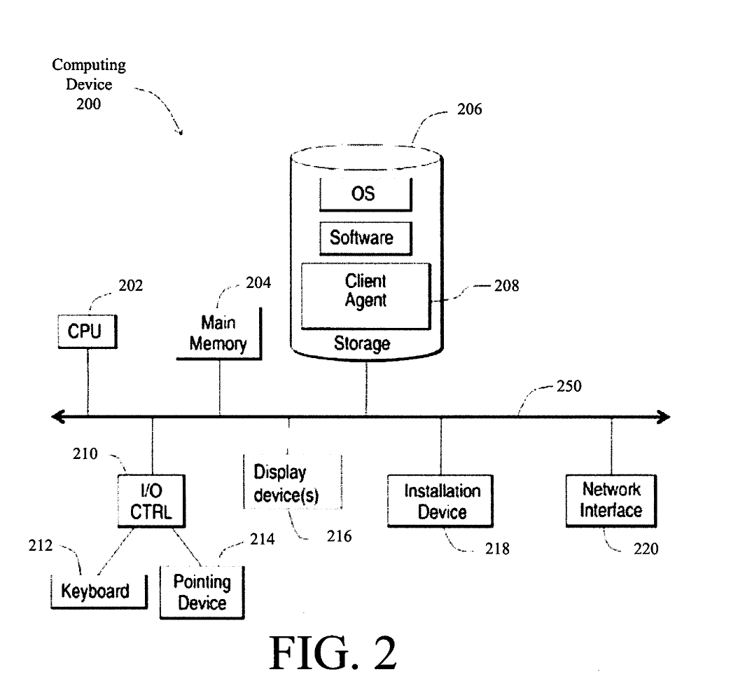

Referring now to FIG. 2, there is provided an illustration of an exemplary computing device 200. The clients 102 and servers 116 may be the same as or substantially similar to computing device 200. As such, the discussion of computing device 200 is sufficient for understanding components 102, 116 of FIG. 1. Computing device 200 includes, but is not limited to, a workstation, a desktop computer, a laptop computer, a notebook computer, a server, a handheld computer, a mobile telephone, and/or a smart phone.

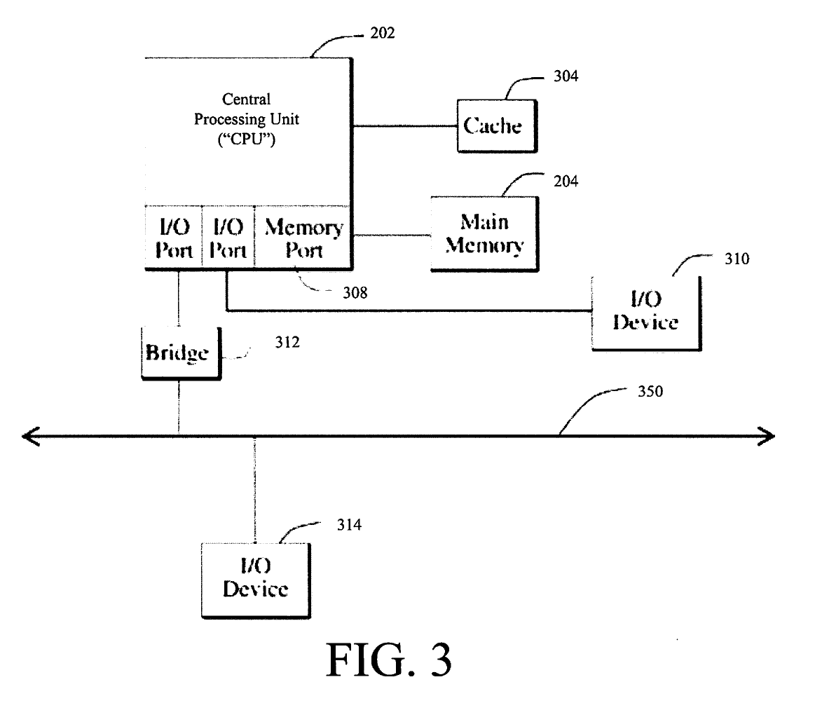

As shown in FIG. 2, the computing device 200 comprises a Central Processing Unit (“CPU”) 202, a main memory 204, at least one display device 216, a keyboard 212, and a pointing device 214 (e.g., a mouse). The computing device 200 may also include additional optional elements. The optional elements include, but are not limited to, Input/Output (“I/O”) devices 310, 312, a bridge 312 and a cache 304 in communication with the CPU 202, as shown in FIG. 3.

The CPU 202 is any logic circuitry that responds to and processes instructions fetched from the main memory 204. In some scenarios, CPU 202 comprises a microprocessor. The microprocessor can include, but is not limited to, a microprocessor manufactured by (a) Intel Corporation of Mountain View, Calif., (b) Motorola Corporation of Schaumburg, Ill., (c) Transmeta Corporation of Santa Clara, Calif., (d) International Business Machines of White Plains, N.Y., (d) Advanced Micro Devices of Sunnyvale, Calif. The computing device 200 may be based on any of these processors, or any other processor capable of operating as described herein.

Main memory 204 includes at least one memory device capable of storing data and allowing any storage location to be directly accessed by the CPU 202. In this regard, main memory 204 includes, but is not limited to, a Static Random Access Memory (“SRAM”), a burst SRAM, a synchBurst SRAM (“BSRAM”), a Dynamic Random Access Memory (“DRAM”), a Fast Page Mode DRAM (“FPM DRAM”), an Enhanced DRAM (“EDRAM”), an Extended Data Output RAM (“EDO RAM”), an Extended Data Output DRAM (“EDO DRAM”), a Burst Extended Data Output DRAM (“BEDO DRAM”), an Enhanced DRAM (“EDRAM”), a synchronous DRAM (“SDRAM”), a JEDEC SRAM, a PC100 SDRAM, a Double Data Rate SDRAM (“DDR SDRAM”), an Enhanced SDRAM (“ESDRAM”), a SyncLink DRAM (“SLDRAM”), a Direct Rambus DRAM (“DRDRAM”), and/or a Ferroelectric RAM (“FRAM”).

In some scenarios, CPU 202 communicates with main memory 204 via a system bus 350 and/or a memory port 308, as shown in FIG. 3. CPU 202 also communicates with cache 304 via system bus 350 and/or a secondary bus (e.g., a backside bus). Cache 304 typically has a faster response time than main memory 204. Cache 304 includes, but is not limited to, an SRAM, a BSRAM and/or an EDRAM. CPU 202 may also communicate with various I/O devices 314 via system bus 350 and I/O devices 310 via a direct connection therewith. System bus 350 includes, but is not limited to, a VESA local bus, an industry Standard Architecture (“ISA”) bus, an Extended ISA (“EISA”) bus, a Micro-Channel Architecture (“MCA”) bus, a PCI bus, a PCI-X bus, a PCI-Express bus, and/or a NuBus. CPU 202 may further communicate with display device(s) 216 via an Advanced Graphics Port (“AGP”).

I/O devices 310, 314 include, but are not limited to, keyboards, mice, trackpads, trackballs, microphones, drawing tablets, video displays, speakers, inkjet printers, laser printers, dye-sublimation printers, data stores, an installation medium and/or a bridge. I/O devices 310, 314 are controlled by an I/O controller 210.

Computing device 200 supports any suitable installation device 218 (e.g., a floppy disk drive, a CD-ROM drive, a CD-R/RW drive, a DVD-ROM drive, tape drives, USB device, hard-drive or any other device suitable for installing software and programs). Computing device 200 comprises a data store 206. Data store 206 includes, but is not limited to, at least one hard disk drive and/or a redundant array of independent disks. Data store 206 stores an Operating System (“OS”), other software and a client agent 208. In some scenarios, the installation device 218 is used as a data store. The OS and the software can be additionally or alternatively run from a bootable medium (e.g., a bootable CD such as KNOPPIX® and/or a bootable CD for GNU/Linux that is available as a GNU/Linux distribution from knoppix.net).

The OS controls scheduling of tasks and access to system resources. OS includes, but is not limited to, a Microsoft® Windows OS, a Unix and Linux OS, a Mac OS®, an embedded OS, a real-time OS, an open source OS, a proprietary OS, an OS for mobile computing devices, or any other OS capable of running on the computing device and performing the operations described herein.

Computing device 200 further includes a network interface 220. The network interface 220 provides an interface to at least one network. The network can include, but is not limited to, a LAN and/or a WAN. The network interface 118 includes, but is not limited to, a built-in network adapter, a network interface card, a PCMCIA network card, a card bus network adapter, a wireless network adapter, a USB network adapter, a modem or any other device suitable for interfacing the computing device 200 to any type of network capable of communication and performing the operations described herein.

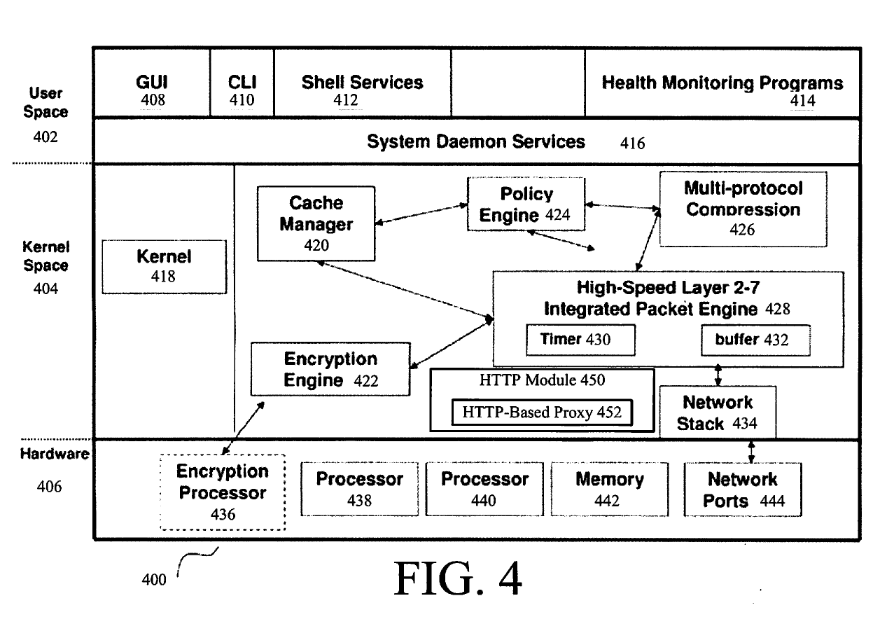

Referring now to FIG. 4, there is provided an illustration of an exemplary architecture for a network appliance 400. Network appliances 106, 110 of FIG. 1 are the same as or substantially similar to network appliance 400. As such, the discussion of network appliance 400 is sufficient for understanding network appliances 106, 110 of FIG. 1. Network appliance 400 includes, but is not limited to, a WAN virtualization device (or WAN virtualizer).

As shown in FIG. 4, network appliance 400 comprises a hardware layer 406 and software layers 402, 404. The software layers include a user space 402 and a kernel space 404. Hardware layer 406 provides the hardware elements upon which programs and services within kernel space 404 and user space 402 are executed. Hardware layer 406 also provides the structures and elements which allow programs and services within kernel space 404 and user space 402 to communicate data both internally and externally with respect to network appliance 400. The hardware layer 206 includes at least one processor 438, 440 for executing software programs and services, a memory 442 for storing software and data, network ports 444 for transmitting and receiving data over a network, and an encryption processor 436 for performing functions related to Secure Sockets Layer (“SSL”) and/or Transport Layer Security (“TLS”) processing of data transmitted and received over the network.

An OS of network appliance 400 allocates, manages, or otherwise segregates the available system memory into kernel space 404 and user space 402. The OS includes, but is not limited to, a Microsoft® Windows OS, a Unix® OS, a Linux® OS, a Mac® OS, an embedded OS, a network OS, a real-time OS, an open source OS, a proprietary OS, and/or an OS for mobile computing devices or network devices.

Kernel space 404 is reserved for running the kernel 418. Kernel 418 includes, but is not limited to, device drivers, kernel extensions or other kernel related software. Kernel 418 is the core of the OS and provides access, control, and management of resources and hardware-related elements of the network appliance 400. Kernel space 404 also includes a number of network services or processes working in conjunction with a cache manager 420.

As shown in FIG. 4, kernel space 404 comprises a plurality of components 418-434. In some scenarios, components 422 and 428-434 alternatively reside in user space 402, instead of kernel space 404. Either architecture can be employed herein without limitation.

Network stack 434 (e.g., a TCP/IP based protocol stack and/or an HTTP/2.0 protocol stack) is provided for communicating with client devices (e.g., clients 102 of FIG. 1) and/or servers (e.g., servers 116 of FIG. 1). The network stack 434 is used to communicate with a first network (e.g., network 104 or 112 of FIG. 1) and a second network (e.g., network 108 of FIG. 1). In this regard, the network appliance 400 terminates a first transport layer connection (e.g., an HTTP/2 connection 150 of FIG. 1) to a client (e.g., client 102a of FIG. 1) and establishes a second transport layer connection (e.g., WAN connection 152 of FIG. 1) to another network appliance (e.g., network appliance 110 of FIG. 1). Alternatively or additionally, the network appliance 400 terminates a third transport layer connection (e.g., an HTTP/2 connection 154 of FIG. 1) to a server (e.g., server 116a of FIG. 1) and establishes a second transport layer connection (e.g., a WAN connection 152 of FIG. 1) to another network appliance (e.g., network appliance 106 of FIG. 1).

Kernel space 404 also comprises a cache manager 420, a high-speed layer 2-7 integrated packet engine 428, an encryption engine 422, a policy engine 424 and multi-protocol compression logic 426. Running these components or processes 420-428 in kernel space 404 or kernel mode instead of the user space 402 improves the performance of each of these components, alone and in combination.

Kernel operation means that these components or processes 420-428 run in the core address space of OS of the network appliance 400. For example, running the encryption engine 422 in kernel mode improves encryption performance by moving encryption and decryption operations to the kernel, thereby reducing the number of transitions between the memory space or a kernel thread in kernel mode and the memory space or a thread in user mode. Data obtained in kernel mode may not need to be passed or copied to a process or thread running in user mode, such as from a kernel level data structure to a user level data structure. The number of context switches between kernel mode and user mode are also reduced. Additionally, synchronization of and communications between any of the components or processes 420-428 can be performed more efficiently in the kernel space 404. In some scenarios, a portion of at components or processes 420-428 run or operate in the kernel space 404, while other portions of these components or processes 420-428 run or operate in user space 402.

The network appliance 400 uses a kernel-level data structure providing access to any portion of one or more network packets (e.g., a network packet comprising a request from a client 102a of FIG. 1 or a response from a server 116a of FIG. 1). The kernel-level data structure is provided by the packet engine 424 via a transport layer driver interface or filter to the network stack 434. The kernel-level data structure comprises any interface and/or data accessible via the kernel space 404 related to the network stack 434 and network traffic or packets received or transmitted by the network stack 434. The kernel-level data structure may be used by any of the components or processes 420-428 to perform the desired operation of the component or process.

The cache manager 420 may comprise software, hardware or any combination of software and hardware to provide cache access, control and management of any type and form of content, such as objects or dynamically generated objects served by the originating servers (e.g., servers 116 of FIG. 1). The data, objects or content processed and stored by the cache manager 420 may comprise data in any format (e.g., a markup language) or communicated via any protocol. The cache manager 232 may duplicate original data stored elsewhere or data previously computed, generated or transmitted, in which the original data may require longer access time to fetch, compute or otherwise obtain relative to reading a cache memory element. Once the data is stored in the cache memory element, future use can be made by accessing the cached copy rather than re-fetching or re-computing the original data, thereby reducing the access time. The cache memory element may additionally or alternatively comprise a data object in memory 442 of network appliance 400 and/or memory having a faster access time than memory 442. Cache manager 420 includes any logic, functions, rules, or operations to perform any operations of the network appliance 400 described herein. The cache manager 420 can comprise any type of General Purpose Processor (“GPP”), or any other type of Integrated Circuit (“IC”).

The policy engine 424 may include, but is not limited to, an intelligent statistical engine or other programmable application(s). The policy engine 424 provides a configuration mechanism to allow a user to identify, specify, define or configure a caching policy. Policy engine 424 also has access to memory 442 to support data structures to enable user-selected caching policy decisions. The policy engine 424 may comprise any logic, rules, functions or operations to determine and provide access, control and management of objects, data or content being cached by the network appliance 400 in addition to access, control and management of security, network traffic, network access, compression or any other function or operation performed by the network appliance 400.

The encryption engine 422 comprises any logic, business rules, functions or operations for handling the processing of any security related protocol or any function related thereto. For example, the encryption engine 422 encrypts and decrypts network packets communicated via the network appliance 400. The encryption engine 422 may also setup or establish SSL or TLS connections on behalf of a client (e.g., clients 102 of FIG. 1), servers (e.g., servers 116 of FIG. 1), or network appliance 400. As such, the encryption engine 422 provides offloading and acceleration of SSL processing. The encryption engine 422 may use a tunneling protocol to provide a Virtual Private Network (“VPN”) between two network appliances and/or between a client and a server.

The Multi-Protocol Compression Engine (“MPCE”) 426 comprises any logic, business rules, function or operations for compressing one or more protocols of a network packet. MPCE 426 compresses bi-directionally between clients and servers any TCP/IP based protocol. The TCP/IP based protocol includes, but is not limited to, Messaging Application Programming Interface (“MAPI”), File Transfer Protocol (“FTP”), HyperText Transfer Protocol (“HTTP”), Common Internet File System (“CIFS”) protocol, Independent Computing Architecture (“ICA”) protocol, Remote Desktop Protocol (“RDP”), Wireless Application Protocol (“WAP”), Mobile IP protocol, and/or Voice Over IP (“VoIP”) protocol. MPCE 426 may additionally or alternatively provide compression of Hypertext Markup Language (“HTML”) based protocols, markup languages (e.g., Extensible Markup Language (“XML”), a high-performance protocol, any payload of or any communication using a TCP and/or IP based protocol.

High speed layer 2-7 Integrated Packet Engine (“IPE”) 428 is responsible for managing the kernel-level processing of packets received and transmitted by network appliance 400 via network ports 444. WE 428 may comprise a buffer for queuing one or more network packets during processing, such as for receipt of a network packet or transmission of a network packer. Additionally, IPE 428 is in communication with one or more network stacks 434 to send and receive network packets via network ports 444. IPE 428 works in conjunction with encryption engine 422, cache manager 420, policy engine 424 and multi-protocol compression logic 426. In particular, encryption engine 234 is configured to perform SSL processing of packets. Policy engine 424 is configured to perform functions related to traffic management such as request-level content switching and request-level cache redirection. Multi-protocol compression logic 426 is configured to perform functions related to compression and decompression of data.

IPE 428 includes a timer 430 which provides one or more time intervals to trigger the processing of incoming (i.e., received) or outgoing (i.e., transmitted) network packets. In some scenarios, operations of the encryption engine 422, cache manager 420, policy engine 424 and multi-protocol compression logic 426 may be performed responsive to the timer 430 and/or the packet engine 428.

In contrast to kernel space 404, user space 402 is the memory area or portion of OS used by user mode applications or programs otherwise running in user mode. A user mode application may not access kernel space 404 directly and uses service calls in order to access kernel services. As shown in FIG. 4, user space 402 includes a Graphical User Interface (“GUI”) 408, a Command Line Interface (“CLI”) 410, shell services 412, health monitoring program 414, and system daemon services 416.

GUI 408 and CLI 410 provide a means by which a system administrator or other user can interact with and control the operation of network appliance 400. GUI 408 may be any type and form of graphical user interface and may be presented via text, graphical or otherwise, by any type of program or application, such as a browser. The CLI 212 may be any type and form of command line or text-based interface, such as a command line provided by the operating system. The shell services 412 comprises the programs, services, tasks, processes or executable instructions to support interaction with the network appliance 400 or OS by a user via GUI 408 and/or CLI 410.

Health monitoring program 414 is used to monitor, check, report and ensure that network systems are functioning properly and that users are receiving requested content over a network. Health monitoring program 414 comprises one or more programs, services, tasks, processes or executable instructions to provide logic, rules, functions or operations for monitoring any activity of network appliance 400. For example, the health monitoring program 414 may (a) intercept and inspect any network traffic passed via the network appliance 400, (b) call any Application Programming Interface (“API”) to determine a state, status, or health of any portion of network appliance 400, and/or (c) check any status, error or history logs provided by any program, process, service or task to determine any condition, status or error with any portion of network appliance 400.

System Daemon Services (“SDSs”) 416 are programs that run continuously or in the background and handle periodic service requests received by network appliance 400. For example, SDSs 416 may (a) forward requests to other programs or processes, and/or (b) perform continuous or periodic system wide functions (e.g., network control).

As shown in FIG. 4, an HTTP module 450 is also provided in the kernel space 404. The HTTP module 450 is generally configured to implement methods discussed herein for providing HTTP/2 optimization through multiple links. These methods will become more evident as the discussion progresses. In this regard, the HTTP module 450 comprises an HTTP-based proxy 452.

During operation, the HTTP module 450: receives data packets from an end node (e.g., a client device or a server); processes the data packets to identify HTTP/2 packets and non-HTTP packets; causes the non-HTTP packets to bypass the HTTP-based proxy 452; parses a priority designator from a header of each HTTP/2 packet; and forwards to the HTTP-based proxy 452 the priority designators, the HTTP/2 packets and CNC information specifying a QoS for each established communications path between the network appliance 400 and another network appliance. The HTTP-based proxy 452 then performs operations to: cause the HTTP/2 packets to be sent over respective communication links (established between the two network appliances) based on the priority designators and CNC information; and/or dynamically adjust a total number of communications links established between the two network appliances based on a total number of data streams being sent over at least one HTTP/2 communication link established between the end node (e.g., a client device or server) and a network appliance.

The HTTP module 450 also monitors all HTTP/2 connections (e.g., HTTP/2 connection 140 of FIG. 1). When a new connection is formed, the network appliance 400 proxies this HTTP/2 connection to a server. For every data stream in an HTTP/2 connection, the proxy creates a new WAN (e.g., TCP) connection (e.g., WAN connection 152 of FIG. 1) between the network appliances (e.g., network appliances 106, 110 of FIG. 1). For optimization, the HTTP-based proxy 452 creates a new WAN connection in advance. For example, if the HTTP-based proxy 452 has identified four (4) data streams within the HTTP/2 connection (e.g., HTTP/2 connection 140 of FIG. 1), then the HTTP-based proxy 452 creates five (5) WAN connections (e.g., WAN connections 152 of FIG. 1) in advance in anticipation of a new data stream within the HTTP/2 connection. Thus, when a new data stream is formed, it will directly use the already created WAN connection, while the HTTP-based proxy 452 creates a new WAN connection N+1 in anticipation. The network appliance on the other end of the network (e.g., network 108 of FIG. 1) will receive all these proxied WAN connections and multiplex the data sent thereover onto a single LAN connection (e.g., LAN connection 154 of FIG. 1) with the server.

Now based on the HTTP data stream priorities, the HTTP-based proxy 452 assigns the proxied WAN connections its priority. This priority is then used to determine the link that the WAN packets from that connection will take. Dependent data streams will be sent with a lower priority than the parent data streams, and be take care on the other end of the proxy connection.

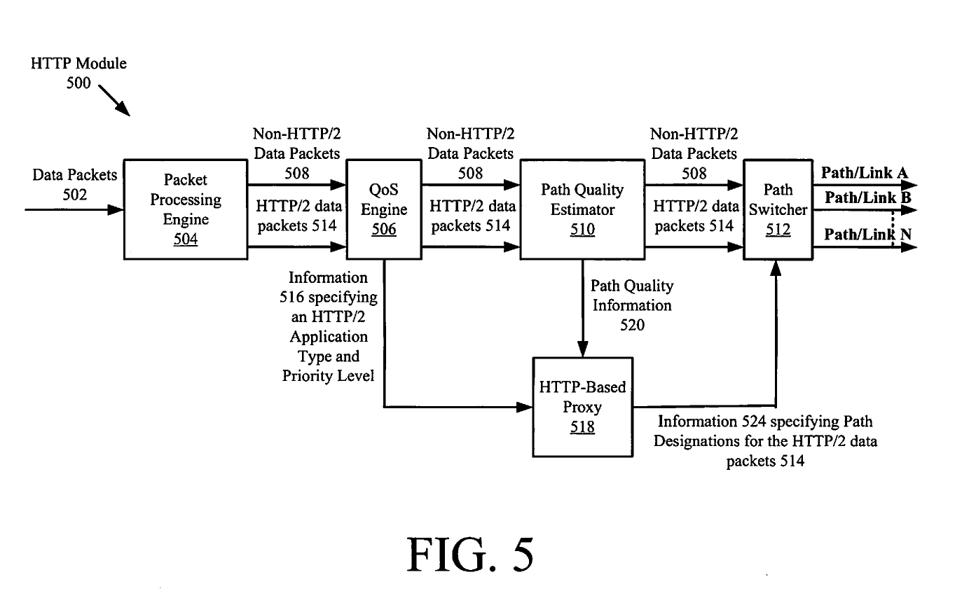

Referring now to FIG. 5, there is provided a functional block diagram of an exemplary architecture for an HTTP module 500. The HTTP module 450 of FIG. 4 is the same as or substantially similar to HTTP module 500. As such, the discussion of HTTP module 500 is sufficient for understanding HTTP module 450 of FIG. 4.

As shown in FIG. 5, the HTTP module 500 comprises a packet processing engine 504, a QoS engine 506, a path quality estimator 510, a path switcher 512 and an HTTP-based proxy 518. HTTP-based proxy 452 of FIG. 4 is the same as or substantially similar to HTTP-based proxy 518. As such, the discussion of HTTP-based proxy 518 is sufficient for understanding HTTP-based proxy 452.

During operation, the HTTP module 500 receives data packets 502 sent over LAN connections (e.g., LAN connections 150, 154 of FIG. 1) of a first network (e.g., network 104 or 112 of FIG. 1). The data packets 502 are processed by a packet processing engine 504 to identify non-HTTP/2 data packets and HTTP/2 data packets. The non-HTTP/2 data packets are sent to path switcher 512 via components 506 and 510, thereby bypassing HTTP-based proxy operations. The path quality estimator 510 determines which path (or link) A, B, . . . , N each non-HTTP/2 packet is to be sent over based on the respective priority level and/or current network conditions (e.g., quality of each path/link). Thereafter, the path quality estimator 510 forwards the non-HTTP packet with a path (or link) designation to the path switcher 512. Path switcher 512 performs operations to: re-format the non-HTTP/2 data packets in accordance with a second network protocol (e.g., a TCP protocol); and allocate the re-formatted data packets to the path (or link) A, B, . . . , N associated with the path (or link) designation in accordance with conventional algorithms.

In contrast, the HTTP/2 data packets 514 are forwarded to the QoS engine 506. The QoS engine 506 processes each HTTP/2 data packet to obtain header information 516 specifying an HTTP/2 application type and priority level therefrom. This information 516 is communicated from the QoS engine 506 to the HTTP-based proxy 518.

Notably, at this time, the HTTP-based proxy 518 has knowledge of the current conditions of the second network (e.g., network 108 of FIG. 1). In this regard, it should be understood that a path quality estimator 510 is provided to continuously or periodically determine the quality of each path (or link) A, B, . . . , N through the second network. For example, the path quality estimator 510 determines that path A has a low latency and packet loss as compared to that of paths B, . . . , N. Path quality information 520 indicating the determined quality of each path (or link) A, B, . . . , N is then provided from the path quality estimator 510 to the HTTP-based proxy 518.

At the HTTP-based proxy 518, a mapping is performed to respectively allocate each data packet to a path (or link) A, B, . . . , N. In this regard, the HTTP-based proxy 518 derives a revised priority level for each path A, B, . . . , N based on the path quality information 520. The HTTP/2 data packet is then allocated to a particular path (or link) A, B, . . . , or N based on information 516 (i.e., the HTTP/2 application type and priority level). The HTTP-based proxy 518 then sends the packets over another HTTP connection that was created between the WAN virtualizes via the path switcher 512. In this regard, the HTTP-based proxy 518 sends information 524 to the path switcher 512 specifying which path(s) the HTTP/2 data packets should be sent over.

At the path switcher 512, the format of the HTTP/2 data packets is translated into a second network protocol format (e.g., a TCP format). The path switcher 512 uses information 524 to respectively allocate the re-formatted data packets to paths (or links) A, B, . . . , N.

In sum, the HTTP module 500 determines the following: link quality of paths (or links) A, B, . . . , N; an HTTP application type for each HTTP/2 data packet; a priority level for each HTTP/2 data packet; and path assignments for HTTP/2 data packet based on the path link qualities, HTTP application types, and priority levels.

In some scenarios, the HTTP module 500 estimates the quality of links accurately because the WAN virtualization module works as a pair across these paths or links. The HTTP module 500 sends control packets to estimate the link quality. In particular, the HTTP module 500 obtains the packet drop rate and latency of the WAN links A, B, . . . , N. The HTTP module 500 can also be tuned to obtain information on the latency and packet drop probability of the links between the end-points and the WAN virtualization appliance by calculating the current Round-Trip-Times (“RTTs”) involved, and by maintaining some historical data about the packet loss.

Based on information 516 (i.e., the HTTP application type and priority level), the HTTP module 500 assigns a revised priority to the proxy WAN connection (e.g., WAN 1 link 152 of FIG. 1) based on the HTTP/2 priority of the stream it is proxying. When a new stream is added to the HTTP/2 connection (e.g., HTTP/2 connection 140 of FIG. 1), the HTTP module 500 creates a new WAN connection in advance. Based on the priority of the proxy WAN connection, the path switcher 512 identifies the path along which packets from each HTTP/2 data stream should be sent.

Exemplary Methods For Providing HTTP/2 Optimization Through Multiple Links

The present solution concerns optimizing HTTP/2 traffic in a system (e.g., system 100 of FIG. 1). More specifically, the present solution concerns systems and methods for optimizing different data streams which flow through one HTTP/2 connection (e.g., HTTP connection 140 of FIG. 1). The present solution is designed to facilitate quick delivery of high priority data streams while low priority data streams do not compete for resources. The resources include, but are not limited to, communication links that operate between the clients (e.g., clients 102 of FIG. 1) and servers (e.g., servers 116 of FIG. 1).

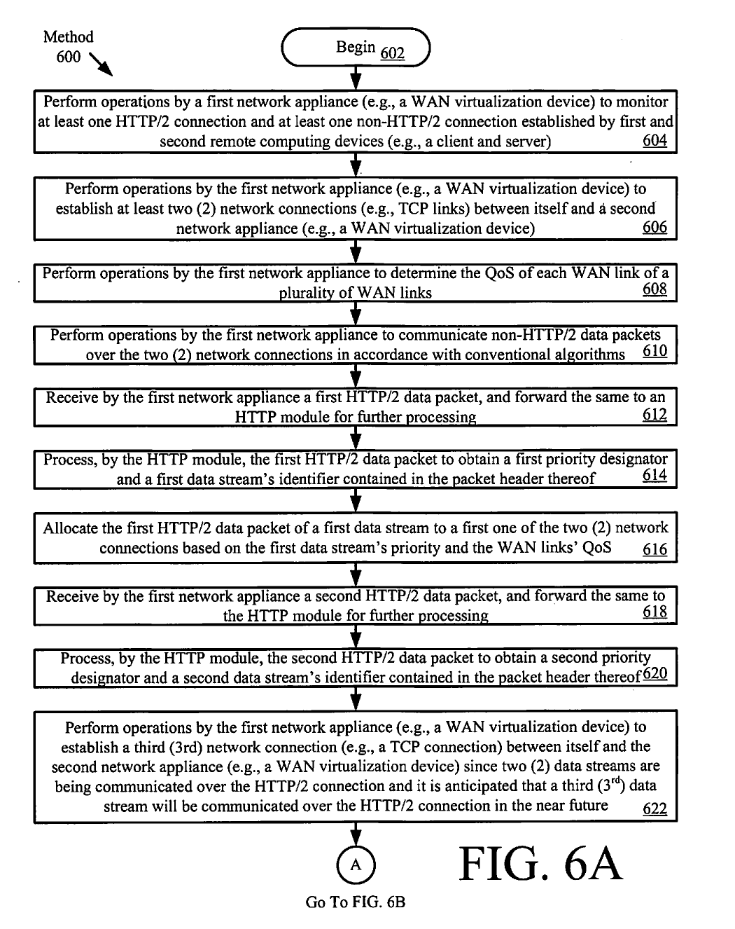

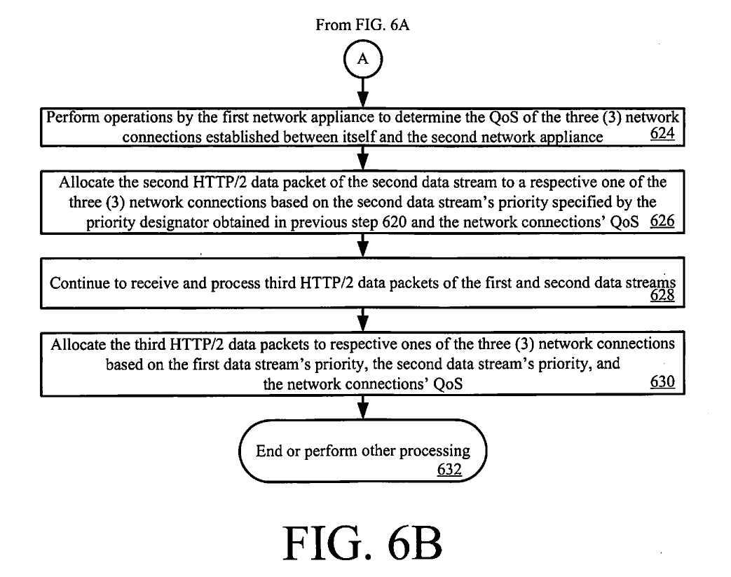

Referring now to FIG. 6, there is provided a flow diagram of an exemplary method 600 for providing HTTP/2 optimization through multiple links. Method 600 begins with step 602 and continues with step 604 where a first network appliance (e.g., network appliance 106 of FIG. 1) performs operations to monitor at least one HTTP/2 connection (e.g., HTTP connection 140 of FIG. 1) established between first and second remote computing devices (e.g., computing devices 102a and 116a of FIG. 1). The first network appliance may also monitor at least one non-HTTP/2 connection (e.g., non-HTTP connection 160 of FIG. 1).

In a next step 606, the first network appliance also performs operations to establish at least two (2) network connections (e.g., links A, B, . . . , N of FIG. 5) between itself and a second network appliance (e.g., network appliance 110 of FIG. 1). A first network connection (e.g., link A of FIG. 5) is established because of an assumption that at least a first HTTP/2 data stream is communicated over the HTTP/2 connection (e.g., HTTP connection 140 of FIG. 1) being monitored. A second network connection (e.g., link B of FIG. 5) is established in anticipation of a second HTTP/2 data stream being communicated over the HTTP/2 connection (e.g., HTTP connection 140 of FIG. 1) in the near future.

Thereafter, step 608 is performed where the first network appliance determines a QoS of each WAN link of a plurality of WAN links. The non-HTTP/2 data packets are communicated over the two (2) network links is accordance with conventional algorithms, as shown by step 610. The format of the non-HTTP/2 data packets may be changed from a first network format to a second network format (e.g., to a TCP format) prior to being communicated over the network connections.

In contrast, the HTTP/2 data packets are communicated over the two (2) network connections in accordance with the novel algorithm described herein, as shown by steps 612-630. These steps involve: receiving by the first network appliance a first HTTP/2 data packet; forwarding the first HTTP/2 data packet to an HTTP module (e.g., HTTP module 450 of FIG. 4) for further processing; process the first HTTP/2 data packet to obtain a first priority designator and a first data stream's identifier contained in the packet header thereof; and allocating the first HTTP/2 data packet of a first data stream to a first one of the two (2) network connections based on the first data stream's priority and the WAN links' QoS. HTTP/2 data packet headers are well known in the art, and therefore will not be described herein. Techniques for parsing data from packet headers are also well known in the art. Any known or to be known data parsing technique can be employed herein without limitation.

Steps 618-620 involve: receiving by the first network appliance a second HTTP/2 data packet; forwarding the second HTTP/2 data packet to an HTTP module (e.g., HTTP module 450 of FIG. 4) for further processing; and processing the second HTTP/2 data packet to obtain a second priority designator and a second data stream's identifier contained in the packet header thereof. If the second data stream's identifier is different than the first data stream's identifier, then the first and second data streams are determined to be different data streams. In this case, the first network appliance performs operations in step 622 to establish a third (3^{rd}) network connection (e.g., a TCP connection) between itself and the second network appliance since two (2) data streams are being communicated over the HTTP/2 connection (e.g., HTTP/2 connection 140 of FIG. 1) and it is anticipated that a third (3^{rd}) data stream will be communicated over the HTTP/2 connection in the near future.

Upon completing step 622, method 600 continues with step 624 of FIG. 6B. Step 624 involves performing operations by the first network appliance to determine the QoS of the three (3) network links (e.g., link A, B, C of FIG. 5) established between itself and the second network appliance. Thereafter, the second HTTP/2 packet is allocated in step 626 to a respective one of the three (3) network links based on the second data stream's priority specified by the priority designator obtained in previous step 620 and the network links' QoS.

Subsequently, the first network appliance continues to receive and process HTTP/2 data packets of the first and second data streams, as shown by step 628. The third HTTP/2 data packets are allocated in step 630 to respective ones of the three (3) network connections based on the first data stream's priority, the second data stream's priority and the network connections' QoS. In a next step 632, method 600 ends or other processing is performed.

All of the apparatus, methods, and algorithms disclosed and claimed herein can be made and executed without undue experimentation in light of the present disclosure. While the invention has been described in terms of preferred embodiments, it will be apparent to those having ordinary skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those having ordinary skill in the art are deemed to be within the spirit, scope and concept of the invention as defined.

The features and functions disclosed above, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

We claim:

1. A method for optimizing different data streams which flow through an HTTP/2 connection established between a first remote computing device and a second remote computing device, comprising:
establishing at least first and second network connections between a first network appliance and a second network appliance prior to knowing how many HTTP/2 data streams are being multiplexed over the HTTP/2 connection;
determining, by the first network appliance, a QoS of each Wide Area Network (“WAN”) link of a plurality of WAN links;
receiving, by the first network appliance, a first HTTP/2 data packet communicated over the HTTP/2 connection;
obtaining a first priority designator and a first data stream's identifier contained in the packet header of the first HTTP/2 data packet; and
allocating the first HTTP/2 data packet of a first data stream to the first or second network connection based on the first data stream's priority and the WAN links' QoS.

2. The method according to claim 1, wherein the first and second network appliances comprise network virtualization devices and each of the first and second remote computing devices comprises a client or a server.

3. The method according to claim 1, further comprising:
monitoring, by the first network appliance, a non-HTTP/2 connection; and
communicating non-HTTP data packets over at least one of the plurality of WAN links without performance of HTTP/2-based proxying functions by the first network appliance.

4. The method according to claim 1, further comprising formatting the first HTTP/2 data packet in accordance with a protocol stack of a network in which the first and second network connections have been established, prior to when the first HTTP/2 data packet is allocated to the WAN link.

5. The method according to claim 1, further comprising:
receiving, by the first network appliance, a second HTTP/2 data packet multiplexed over the HTTP/2 connection; and
processing the second HTTP/2 data packet to obtain a second priority designator and a second data stream's identifier contained in the packet header thereof.

6. The method according to claim 5, further comprising performing operations, by the first network appliance, to establish a third network connection between the first network appliance and the second network appliance when the first and second data streams are different data streams indicating that two different data streams are being multiplexed over the HTTP/2 connection.

7. The method according to claim 6, further comprising performing operations by the first network appliance to determine the QoS of the first, second and third network connections.

8. The method according to claim 7, further comprising allocating the second HTTP/2 packet to a respective one of the first, second and third network connections based on (a) the second data stream's priority specified by the second priority designator and (b) the QoS of the first, second and third network connections.

9. The method according to claim 8, wherein HTTP/2 data packets of the second data stream are allocated to one of the first, second and third network connections which is different than the network connection to which HTTP/2 data packets of the first data stream are allocated.

10. A system, comprising:
a first network appliance in communication with a first computing device via a first network; and
a second network appliance in communication with the first network appliance via a second network different than the first network;
wherein at least first and second network connections are established between the first network appliance and the second network appliance prior to when the first network appliance has knowledge about how many HTTP/2 data streams are being multiplexed over an HTTP/2 connection; and
wherein the first network appliance is configured to
determine a QoS of each Wide Area Network (“WAN”) link of a plurality of WAN links,
receive a first HTTP/2 data packet communicated over the HTTP/2 connection, obtain a first priority designator and a first data stream's identifier contained in the packet header of the first HTTP/2 data packet, and
allocate the first HTTP/2 data packet of a first data stream to the first or second network connection based on the first data stream's priority and the WAN links' QoS.

11. The system according to claim 10, wherein the first and second network appliances comprise network virtualization devices and the first computing device comprises a client or a server.

12. The system according to claim 10, wherein the first network appliance is further configured to:
monitor a non-HTTP/2 connection; and
communicate non-HTTP data packets over at least one of the plurality of WAN links without performance of HTTP/2-based proxying functions by the first network appliance.

13. The system according to claim 10, wherein the first HTTP/2 data packet is formatted in accordance with a protocol stack of a network in which the first and second network connections have been established, prior to when the first HTTP/2 data packet is allocated to the WAN link.

14. The system according to claim 10, wherein the first network appliance is further configured to:
receive a second HTTP/2 data packet multiplexed over the HTTP/2 connection; and
process the second HTTP/2 data packet to obtain a second priority designator and a second data stream's identifier contained in the packet header thereof

15. The system according to claim 14, wherein the first network appliance is further configured to establish a third network connection between the first network appliance and the second network appliance when the first and second data streams are different data streams indicating that two different data streams are being multiplexed over the HTTP/2 connection.

16. The system according to claim 15, wherein the first network appliance is further configured to determine the QoS of the first, second and third network connections.

17. The system according to claim 16, wherein the second HTTP/2 packet is allocated to a respective one of the first, second and third network connections based on (a) the second data stream's priority specified by the second priority designator and (b) the QoS of the first, second and third network connections.

18. The system according to claim 17, wherein HTTP/2 data packets of the second data stream are allocated to one of the first, second and third network connections which is different than the network connection to which HTTP/2 data packets of the first data stream are allocated.
